(19) United States
(12) Patent Application Publication
(10) Pub. No.: US 2016/0251077 A1
(43) Pub. Date: Sep. 1, 2016

(54) Small Flying Object

(71) Applicant: Hitachi, Ltd., Tokyo (JP)

(72) Inventors: Azusa AMINO, Tokyo (JP); Yukio YAMAMOTO, Tokyo (JP)

(21) Appl. No.: 15/052,255

(22) Filed: Feb. 24, 2016

(30) Foreign Application Priority Data
Feb. 27, 2015 (JP) 2015-037627

(51) Int. Cl. B64C 27/10; G05D 1/08; B64C 39/02; B64C 27/00; B64C 27/52; B64C 27/12

(52) U.S. Cl. CPC B64C 27/10; B64C 27/52; B64C 27/12; B64C 39/024; B64C 27/001; G05D 1/0858; B64C 2201/042; B64C 2201/108; B64C 2201/165

(57) ABSTRACT

To provide a small flying object that is inexpensive and capable of stable flying. In order to solve the above problem, a representative example of the small flying object of the present invention includes an upper rotor that generates thrust by rotating, a lower rotor that is disposed below the upper rotor and rotates coaxially with the upper motor and in the opposite direction to the upper motor, and an inertia balancer that is connected to one of the rotors having a lower rotation speed during hovering among the upper rotor and the lower rotor, and rotates integrally with the one rotor. The inertia balancer compensates a difference between an angular momentum of the one rotor and an angular moment of the other rotor during hovering.

### TECHNICAL FIELD

The present invention relates to a small flying object that flies by producing thrust with two rotors.

### BACKGROUND ART

Among flying objects that fly by producing thrust via the rotation of a rotor, there are some that are constituted with two rotors on the top and the bottom, in which a counterforce generated by the rotation of the rotors is cancelled out by rotating the rotors in mutually opposite directions. For example, PTL 1 listed below discloses a well-known example of such flying object.

Paragraph [0014] of PTL 1 discloses the following: “The main rotors 14 and 15 are provided coaxially at an upper and a lower level on the rotation shaft 16. The rotation shaft 16 rotationally drives the lower main rotor 15 and rotatably supports the upper main rotor 14, and the upper main rotor 14 is rotationally driven by a rotation shaft 19 on the inside of the rotation shaft 16. The main rotors 14 and 15 rotate in mutually opposite directions. The rotation shafts 16 and 19 rotationally drive the respective rotor blades by a motor within the main body 13.” Further, Paragraph [0029] of PTL 1 discloses the following: “A yaw axis rate gyro 58 that outputs a command to the main rotor motors 55 and 56, and a roll/pitch axis rate gyro 59 that transmits a signal to the cyclic pitch servomotor 57 and changes an attack angle of the main rotors are also provided.”

### CITATION LIST

### Patent Literature

PTL 1: JP 2013-512149 W

### SUMMARY OF INVENTION

### Technical Problem

In a flying object having counter-rotating rotors as described above, air whose velocity has been increased by the upper rotor flows into the lower rotor. Thus, if the upper and lower rotors are mirror-image symmetrical, the lower rotor must have a higher rotation speed than the upper rotor in order for the flying object to remain stationary relative to the yaw direction. In this way, there has been a problem in that if rotation speeds are generated by the upper and lower rotors, the angular momentum differs between the upper and lower rotors, and thus a whirling movement due to gyro effects is generated when the flying object operates in the pitch or roll direction, and it becomes difficult to stabilize the posture of the flying object.

Herein, in the method disclosed in PTL 1, rotors in which the attack angle of the rotor blade can be changed are provided such that they can rotate in mutually opposite directions on the top and bottom of the same axis, and the posture of the flying body is controlled by changing the rotation speed of the upper and lower rotors and the attack angle of the rotor blades. However, in the conventional technology disclosed in PTL 1, rotors in which the attack angle of the rotor blade can be changed must be used for posture control, and such rotors have a complex structure and it is cumbersome to adjust the length of the link mechanism and the like, and this may lead to increased costs.

Thus, an object of the present invention is to provide a small flying object that is inexpensive and capable of stable flying.

### Solution to Problem

To solve the above problem, one of the representative small flying objects of the present invention includes: an upper rotor that generates thrust by rotating; a lower rotor that is disposed below the upper rotor and rotates coaxially with the upper motor and in the opposite direction to the upper motor; and an inertia balancer that is connected to one of the rotors having a lower rotation speed during hovering among the upper rotor and the lower rotor, and rotates integrally with the one rotor, and the inertia balancer compensates a difference between an angular momentum of the one rotor and an angular momentum of the other rotor during hovering.

### Advantageous Effects of Invention

According to the invention, a small flying object that is inexpensive and capable of stable flying can be provided.

### BRIEF DESCRIPTION OF DRAWINGS

FIG. 1 is an overall perspective view of a small flying object of Embodiment 1 of the present invention.

FIG. 2 is a view explaining a control device 11 of Embodiment 1 of the present invention.

FIG. 3 is a view explaining a control algorithm of Embodiment 1 of the present invention.

FIG. 4 is a view explaining movement around the rotors of Embodiment 1 of the present invention.

FIG. 5 illustrates whirling movement of Embodiment 1 of the present invention.

FIG. 6 is a view explaining angular momentum around the rotors of Embodiment 1 of the present invention.

FIG. 7 illustrates whirling movement of Embodiment 1 of the present invention.

### DESCRIPTION OF EMBODIMENTS

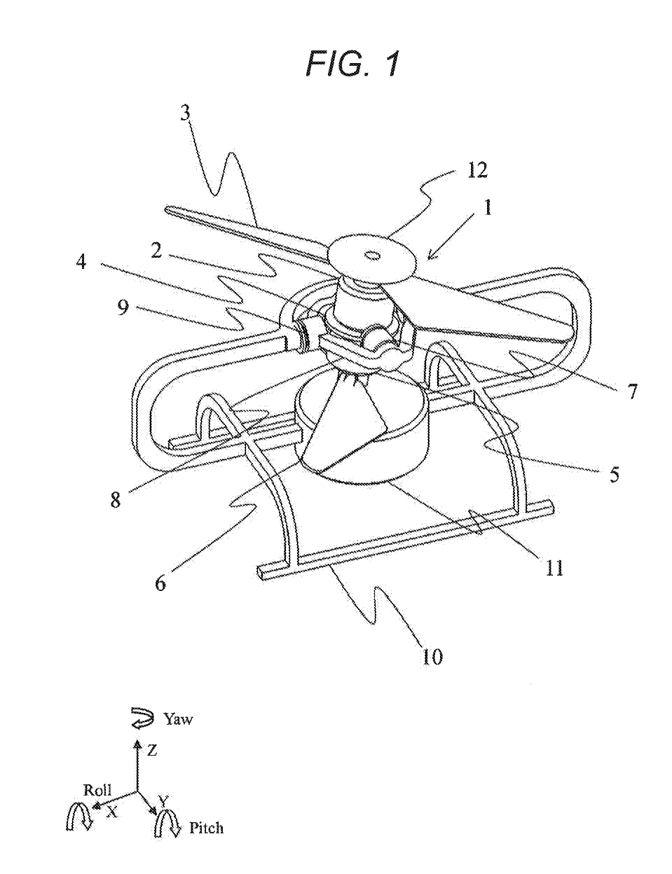

FIG. 1 is an overall perspective view of a small flying object of Embodiment 1 of the present invention. In the following explanations, the direction of travel of the flying object will be referred to as the X axis, the direction of gravity will be referred to as the Z axis, and the axis that is orthogonal to both the X axis and the Z axis will be referred to as the Y axis. Rotation around the X axis will be defined as roll, rotation around the Y axis will be defined as pitch, and rotation around the Z axis will be defined as yaw.

A small flying object 1 shown in FIG. 1 includes the following as a thrust generation part for making the small flying object 1 float: an upper rotor 3 having a rotor blade, an upper motor 2 for driving the upper rotor 3, a lower motor 5 that is driven in a rotation direction opposite to that of the upper motor 2 and is disposed so that its rotation axis is coaxial with that of the upper motor 2, and a lower rotor 6 that is driven by the lower motor 5 and has a rotor blade. An inertia 12, which is disposed to rotate integrally and is constituted symmetrically relative to the rotation axis of the upper rotor 3, is provided to a rotating part of the upper rotor 3 and the upper motor 2.

For the purpose of changing the thrust direction of the thrust generation part in the pitch and roll directions in order to perform posture control of the small flying object 1, the following are also provided: a center gimbal part 4 which has the upper motor 2 at a top part thereof and has the lower motor 5 in the opposite direction; a pitch drive motor 7 that is provided on a bottom end of the center gimbal part 4 and includes an output part so as to be capable of rocking the center gimbal part 4 in the pitch direction; a peripheral gimbal part 8 including the pitch drive motor 7; and a roll drive motor 9 a roll drive motor 9 which includes an output part so as to be capable of rocking the peripheral gimbal part 8 in the roll direction.

The structure supporting the above-described mechanisms is constituted by a main frame 10, which has an approximately symmetrical shape in the X and Y directions relative to the rotation axis of the upper rotor 3 and the lower rotor 6, is provided so as to not obstruct the rotation of the upper rotor 3 and the lower rotor 6, and has a shape that becomes stable when, for example, landing on the ground; and a control device 11 that is provided on a lower part of the main frame 10 so as to reduce the center of gravity of the small flying object 1 as much as possible. The control device 11 occupies the majority of the weight of the small flying object 1, and in order to enhance the stability of the small flying object 1 in the air, the control device 11 should be installed upon positional adjustment so that the center of gravity of the small flying object 1 is positioned on the rotation axis of the upper rotor 3 and the lower rotor 6.

The upper rotor 3 and the lower rotor 6 are driven to rotate in mutually opposite directions to generate thrust vertically downwards and make the small flying object 1 fly. The thrust can be changed by changing the rotation speed of the upper rotor 3 and the lower rotor 6. By rotating in mutually opposite directions, the anti-torque generated when the upper rotor 3 and the lower rotor 6 generate thrust can be utilized so that the movement in the yaw direction can be controlled. The upper motor 2 and the lower motor 5 that drive the upper rotor 3 and the lower rotor 6 are controlled in terms of rotation speed by the control device 11.

The pitch drive motor 7 and the roll drive motor 8 include, for example, a power source such as an electric motor (stepping motor, brushless motor, ultrasonic motor, etc.), a deceleration mechanism, and an angle detector (rotary encoder, potentiometer, etc.) built therein. The pitch drive motor 7 and the roll drive motor 8 are appropriately controlled in terms of rotation angle by the control device 11. By deflecting the direction of thrust generated by the upper rotor 3 and the lower rotor 6 using the pitch drive motor 7 and the roll drive motor 8, the posture of the small flying object 1 is stably controlled.

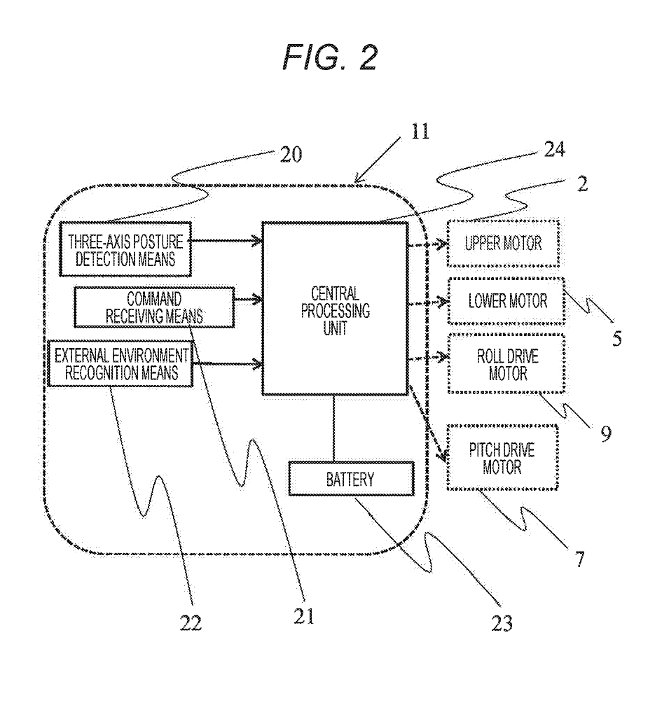

FIG. 2 illustrates a constitution of the control device 11.

The control device 11 includes therein a three-axis posture detection means 20, a command receiving means 21, an external environment recognition means 22, a battery 23, and a central processing unit 24. The three-axis posture detection means 20 is a means that can detect an angle and angular velocity in the roll, pitch, and yaw directions such as, for example, a three-axis gyro, and is used for the purpose of obtaining a posture of the small flying object 1. The command receiving means 21 is a means for receiving an external command, and can receive the command wirelessly or via wires. The external environment recognition means 22 is a sensor that measures the height from the ground of the small flying object 1, a sensor that measures the distance from surrounding objects, or the like. The battery 23 is a power source of the small flying object 1, but, for example, the battery 23 can supply power through a signal wire in the case that the command receiving means 21 is wired. The central processing unit 24 appropriately controls the upper motor 2, the lower motor 5, the roll drive motor 9, and the pitch drive motor 7 on the basis of information from the three-axis posture detection means 20, the command receiving means 21, and the external environment recognition means 22.

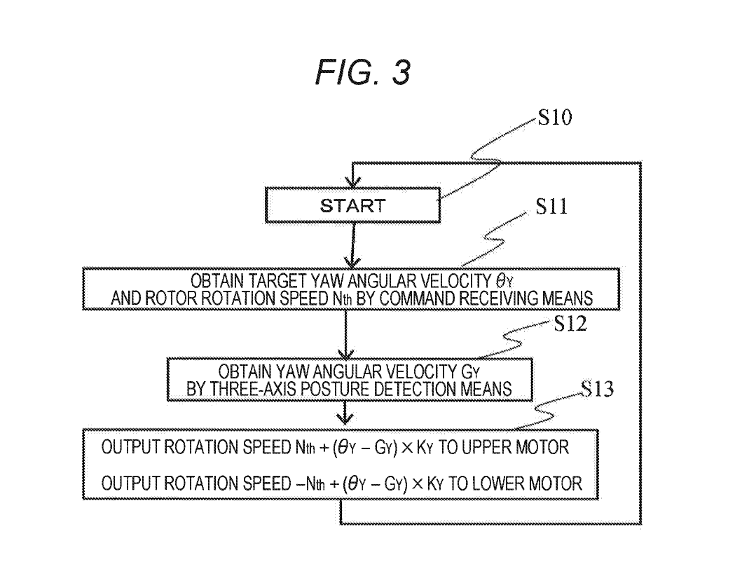

FIG. 3 illustrates a yaw direction control algorithm of the small flying object 1 in Embodiment 1. The method of control will be explained below in order.

A target yaw angular velocity θ_{Y} and a propeller rotation speed Nₜₕ are obtained from the command receiving means 21 (S11).

A yaw angular velocity G_{Y} is obtained by the three-axis posture detection means 20 (S12).

A rotation speed Nₜₕ+(θ_{Y}−G_{Y})×K_{Y} is output to the upper motor, and a rotation speed Nₜₕ+(θ_{Y}−G_{Y})×K_{Y} is output to the lower motor (S13). Herein, with regard to the rotation speed, left rotation is regarded as positive, and K_{y} is a yaw control gain.

Subsequently, the process returns to the beginning. The above steps are executed at predetermined time increments.

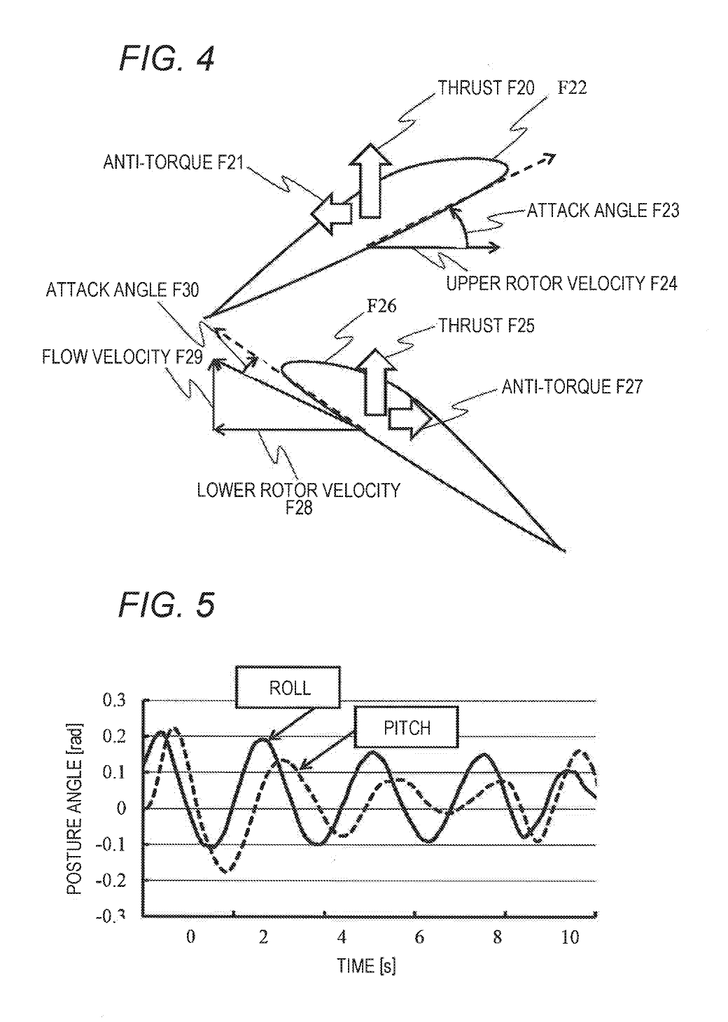

FIG. 4 is a view explaining movement around the rotors when the small flying object is stationary relative to the yaw direction during hovering in Embodiment 1. The cross-sections of the upper rotor 3 and the lower rotor 6 during hovering are indicated as an upper rotor cross-section F22 and a lower rotor cross-section F26. Herein, the upper rotor 3 and the lower rotor 6 are configured with blade cross-sections having the same angle of attack and the same profile considering the availability and cost reduction, and the only difference between the upper rotor 3 and the lower rotor 6 is the mirror-image symmetry.

A velocity when viewed from air on the upper rotor cross-section F22 is an upper rotor velocity F24, an upper rotor attack angle F23, and an upper rotor thrust F20 generated at that time, and the upper rotor anti-torque is F21. A velocity when viewed from air on the lower rotor cross-section F26 is a lower rotor velocity F28, a lower rotor attack angle F29, a lower rotor thrust F25, and a lower rotor anti-torque F27. Since air with whose velocity is increased by the upper rotor 3 flows into the lower rotor cross-section F26, the air has a velocity F29. As a result, the upper rotor attack angle F29 is smaller than the lower rotor attack angle F23. Meanwhile, in order for the small flying object 1 to be stationary relative to the yaw direction, it is necessary for the sizes of the upper rotor anti-torque F21 and the lower rotor anti-torque F27 to be equal. Therefore, the lower rotor 6 having a small attack angle must have a higher rotation speed than that of the upper rotor 3.

Mainly due to cost restrictions, the upper rotor 3 and the lower rotor 6 are often configured with blade cross-sections having the same angle of attack and the same profile with the only difference being the mirror-image symmetry. Further, for the same reasons, the same motor is often used for both the upper motor 2 and the lower motor 5. During hovering, in the present embodiment as described above, the lower rotor 6 has a higher rotation speed than the upper rotor 3. If the total moment of inertia around the Z axis of the upper motor 2 and the upper rotor 3 is I1, the total moment of inertia around the Z axis of the lower motor 5 and the lower rotor 6 is I2, the rotation speed of the upper rotor 3 is w1, and the rotation speed of the lower rotor 6 is w2, then the angular momentums of the upper and lower rotors are I1w1 and I2w2 respectively. If the rotation speeds of the upper rotor 3 and the lower rotor 6 are equal, the angular momentums will cancel each other out. However, since the rotation speed of the lower rotor 6 is higher as explained above, a total angular momentum of the upper and lower rotors exists. As explained above, in the small flying object 1 of the present embodiment, the orientation of the thrust of the upper and lower rotors is deflected with the pitch drive motor 7 and the roll drive motor 8 to perform posture control. Thus, a whirling movement is generated over the entire the small flying object 1 due to gyro effects when the rotor thrust is deflected. FIG. 5 illustrates this whirling movement. Displacement around the pitch and displacement around the roll are generated periodically, and vibrations occur continuously without damping.

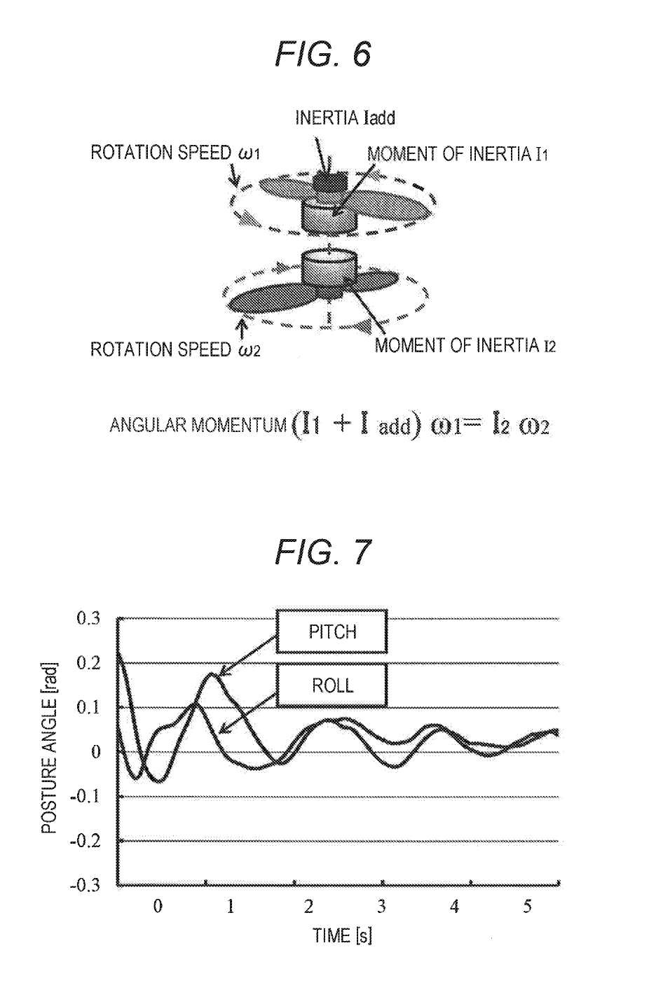

Thus, as shown in FIG. 6, the small flying object 1 of Embodiment 1 includes an inertia I₂ configured to rotate integrally with the upper rotor 3. The moment of inertia of the inertia I₂ is determined as follows.

If the moment of inertia of the inertia I₂ is I_{add}, then from balance conditions of the angular momentum,

(I₁+I_{add})w₁=I₂W₂ Eq. 1

Therefore,

I_{add}=(I₂w₂−I₁w₁)/W₁ Eq. 2

With regard to w₁ and w₂ at this time, the rotation speeds during hovering are measured to calculate the moment of inertia I_{add} of the inertia I₂.

FIG. 7 illustrates the movement around the pitch and around the roll after installing the inertia I₂. By installing the inertia I₂, the whirling movement is reduced and vibrational behavior converges.

As explained above, according to the method of the present invention, a small flying object capable of stable posture control can be realized with a minimal structure using low-cost rotors.

In the present invention, in the small flying object in which posture control is performed by changing in terms of roll and pitch the thrust direction of the thrust generation part having counter-rotating rotors in which the attack angle of the rotor blades is fixed, by imparting an inertial mass to the rotor of the rotors rotating in opposite directions that has a lower rotation speed to balance out the angular momentums of the upper and lower rotors so that the sizes of the angular momentums of the upper and lower rotors become balanced, the angular momentum of the thrust generation part can be brought close to zero, and thereby posture changes due to gyro effects during roll and pitch operations can be reduced.

Further, in the above-described embodiment, the moment of inertia of the inertia I₂ was calculated and imparted so as to balance the angular momentums during hovering of the upper rotor and the lower rotor. However, for example, the moment of inertia to be imparted to the upper rotor can be calculated by predicting the thrust and rotation speed beforehand by simulation or the like, and thereby added in advance to the moment of inertia of the rotating part of the upper motor 2.

### REFERENCE SIGNS LIST

1 small flying object
2 upper motor
3 upper rotor
4 center gimbal part
5 lower motor
6 lower rotor
7 pitch drive motor
8 peripheral gimbal part
9 roll drive motor
10 main frame
11 control device
12 inertia

1. A small flying object, comprising:
an upper rotor that generates thrust by rotating;
a lower rotor that is disposed below the upper rotor and rotates coaxially with the upper motor and in the opposite direction to the upper motor; and
an inertia balancer that is connected to one of the rotors having a lower rotation speed during hovering among the upper rotor and the lower rotor, and rotates integrally with the one rotor,
wherein the inertia balancer compensates a difference between an angular momentum of the one rotor and an angular momentum of the other rotor during hovering.

2. The small flying object according to claim 1, wherein the one rotor is the upper rotor, and the other rotor is the lower rotor.

3. The small flying object according to claim 2, wherein when a moment of inertia of the inertia balancer is Iadd, a moment of inertia of the upper rotor is I1, a moment of inertia of the lower rotor is I2, a rotation speed during hovering of the upper rotor is w1, and a rotation speed during hovering of the lower rotor is w2, the following relationship (Eq. 1) is satisfied:
Iadd=(I2w2−I1w1)/w1. (Eq. 1)

4. The small flying object according to claim 1, further comprising:
a center gimbal part that connects the upper motor and the lower motor;
a first drive motor that drives the center gimbal part to rock in an orientation that intersects a rotation axis of the upper rotor and the lower rotor;
a second drive motor that drives to rock in an orientation that intersects a rocking axis of the first drive motor and the rotation axis of the upper rotor and the lower rotor;
a control device that controls the first drive motor and the second drive motor; and
a control device that performs posture control by controlling the first drive motor and the second drive motor to deflect a thrust direction of the upper rotor and the lower rotor.

5. The small flying object according to claim 1, wherein an angle of attack of a rotor blade of the upper rotor and the lower rotor is fixed.

6. A small flying object, comprising:
an upper rotor that generates thrust by rotating; and
a lower rotor that is disposed below the upper motor and rotates coaxially with the upper motor and in the opposite direction to the upper motor,
wherein an inertia is imparted coaxially with the upper rotor so that angular momentums of the upper rotor and the lower rotor become equal during hovering.
